(19) United States
(12) Patent Application Publication
(10) Pub. No.: US 2009/0269581 A1
(43) Pub. Date: Oct. 29, 2009

(54) HIGH STRENGTH POLYETHYLENE FIBER AND METHOD FOR PRODUCING THE SAME

(75) Inventors: Yasunori Fukushima, Shiga (JP); Godo Sakamoto, Shiga (JP); Ihachiro Iba, Shiga (JP)

Correspondence Address: MORRISON & FOERSTER LLP, 1650 TYSONS BOULEVARD, SUITE 400, MCLEAN, VA, 22102, US

(73) Assignee: Toyo Boseki Kabushiki Kaisha, Osaka-shi, Osaka (JP)

(21) Appl. No.: 12/296,408

(22) PCT Filed: Mar. 22, 2007
(86) PCT No.: PCT/JP2007/055864

§ 371 Date: Oct. 7, 2008

(30) Foreign Application Priority Data
Apr. 7, 2006 (JP) 2006-106302
Apr. 7, 2006 (JP) 2006-106303
Apr. 7, 2006 (JP) 2006-106304
Apr. 7, 2006 (JP) 2006-106305

(51) Int. Cl. D02G 3/02; B29C 47/88

(52) U.S. Cl. 428/364; 264/211.12

(57) ABSTRACT

A polyethylene fiber having high strength and extremely high productivity is difficult to obtain by conventional gel spinning methods. This high strength polyethylene fiber includes an ultrahigh molecular weight polyethylene resin having an intrinsic viscosity of 8 dL/g or more and contains a poor solvent in an amount of 10 ppm or more with respect to the resin. This high strength polyethylene fiber may also contain an ultrahigh molecular weight polyethylene resin having an intrinsic viscosity of 8 dL/g or more in which the resin contains a non-solvent in which the resin is insoluble in an amount of 10 ppm or more.

### REFERENCE TO RELATED APPLICATIONS

This application is a national stage application under 35 USC 371 of International Application No. PCT/JP2007/055864, filed Mar. 22, 2007, which claims the priority of Japanese Patent Application Nos. 2006-106305, 2006-106304, 2006-106303 and 2006-106302, all filed Apr. 7, 2006, the contents of which prior applications are incorporated herein by reference.

### FIELD OF THE INVENTION

The present invention relates to a high strength polyethylene fiber which is of low price and is excellent in strength and elastic modulus, and to a method for producing the same. More particularly, the invention relates to a high strength polyethylene fiber excellent in drawing property, which is characterized by the solvent for polyethylene used in the preparation of a solution in a gel spinning method and the like, and to a method for producing the same.

### BACKGROUND OF THE INVENTION

With regard to high strength polyethylene fiber, it is known that a nonconventional fiber having high strength and high elastic modulus is obtained by a so-called “gel spinning method” using an ultrahigh molecular weight polyethylene as a raw material, and such fiber has already been used widely for industrial applications (for example, Patent Document 1 and Patent Document 2).

Recently, in addition to the above applications, the high strength polyethylene fiber has been widely used in various applications. Furthermore, not only higher strength and higher elastic modulus, but also an improvement in productivity is strongly required. One of the conditions necessary for the improvement of productivity of a polyethylene fiber is excellent drawing property. In the production of the polyethylene fiber, the higher the maximum value of a drawing ratio is, the lower a breakage ratio of filament during drawing is. Furthermore, it becomes possible for a drawing speed to be increased much more.

Patent Document 1: Japanese Patent Publication No. S60-47922 B
Patent Document 2: Japanese Patent Publication No. S64-8732 B

### SUMMARY OF THE INVENTION

Problems to be solved are to realize high productivity (drawing property) which was difficult to be achieved by the conventional gel spinning method, and to provide an inexpensive polyethylene fiber and a method for producing the same.

The inventors of the present invention researched earnestly in order to solve the above-mentioned problems, and have accomplished the present invention. That is, the invention provides (1) a high strength polyethylene fiber comprising an ultrahigh molecular weight polyethylene resin having an intrinsic viscosity of 8 dL/g or more, wherein the fiber contains a poor solvent in an amount of 10 ppm or more with respect to the resin; (2) the high strength polyethylene fiber described in (1), wherein the solvent has a viscosity index of 0.6 or less; (3) the high strength polyethylene fiber described in (1) or (2) produced by preparing a polyethylene dope having a polyethylene concentration of 0.5% by weight or more and less than 50% by weight from an ultrahigh molecular weight polyethylene resin having an intrinsic viscosity of 8 dL/g or more by use of a solvent having a viscosity index of 0.6 or less with respect to the resin, extruding the polyethylene dope through an orifice, and drawing a filament yarn after cooling; (4) the high strength polyethylene fiber of any one described in (1) to (3) produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 20:80 to 99:1, the solvent (A) is a good solvent for the resin, and the solvent (B) is compatible with the solvent (A) and is a poor solvent for the resin; (5) the high strength polyethylene fiber of any one described in (1) to (3) produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 30:70 to 95:5, the solvent (A) is a good solvent for the resin, and the solvent (B) is compatible with the solvent (A) and is a poor solvent for the resin; (6) the high strength polyethylene fiber described in (4) or (5), wherein the solvent (A) has a viscosity index of greater than 0.6 with respect to the ultrahigh molecular weight polyethylene resin having an intrinsic viscosity of 8 dL/g or more, and the solvent (B) has a viscosity index of 0.6 or less; (7) a high strength polyethylene fiber comprising an ultrahigh molecular weight polyethylene resin having an intrinsic viscosity of 8 dL/g or more, wherein the resin contains a non-solvent in which the resin is insoluble in an amount of 10 ppm or more; (8) the high strength polyethylene fiber described in (7) produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 50:50 to 99:1, the solvent (A) is a good solvent for the resin, and the solvent (C) is compatible with the solvent (A) and is a non-solvent in which the resin is insoluble; (9) the high strength polyethylene fiber described in (7) produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 70:30 to 90:10, the solvent (A) is a good solvent for the resin, and the solvent (C) is compatible with the solvent (A) and is a non-solvent in which the resin is insoluble; (10) the high strength polyethylene fiber described in (8) or (9) using the mixed solvent, wherein the solvent (A) has a viscosity index of greater than 0.6 with respect to the ultrahigh molecular weight polyethylene resin having an intrinsic viscosity of 8 dL/g or more; (11) a high strength polyethylene fiber comprising an ultrahigh molecular weight polyethylene resin having an intrinsic viscosity of 8 dL/g or more, wherein the resin contains a solvent having a viscosity index of 0.6 or less with respect to the resin and a non-solvent in which the resin is insoluble in an amount of 10 ppm or more; (12) the high strength polyethylene fiber described in (11) produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 50:50, the solvent (B) is a poor solvent for the resin, and the solvent (C) is compatible with the solvent (B) and is a non-solvent in which the resin is insoluble; (13) the high strength polyethylene fiber described in (11) produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 70:30, the solvent (B) is a poor solvent for the resin, and the solvent (C) is compatible with the solvent (B) and is a non-solvent in which the polyethylene is insoluble; (14) the high strength polyethylene fiber described in (12) or (13), wherein the solvent (B) has a viscosity index of 0.6 or less with respect to the ultrahigh molecular weight polyethylene resin having an intrinsic viscosity of 8 dL/g or more; (15) a method for producing a high strength polyethylene fiber, comprising preparing a polyethylene dope having a polyethylene concentration of 0.5% by weight or more and less than 50% by weight from an ultrahigh molecular weight polyethylene resin having an intrinsic viscosity of 8 dL/g or more by use of a solvent having a viscosity index of 0.6 or less with respect to the resin, extruding the polyethylene dope through an orifice, and drawing a filament yarn after cooling; (16) a method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 20:80 to 99:1, the solvent (A) is a good solvent for the resin, the solvent (B) is compatible with the solvent (A) and is a poor solvent for the resin; (17) a method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 30:70 to 99:5, the solvent (A) is a good solvent for the resin, and the solvent (B) is compatible with the solvent (A) and is a poor solvent for the resin; (18) a method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 50:50 to 99:1, the solvent (A) is a good solvent for the resin, and the solvent (C) is compatible with the solvent (A) and is a non-solvent in which the resin is insoluble; (19) a method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 70:30 to 90:10, the solvent (A) is a good solvent for the resin, and the solvent (C) is compatible with the solvent (A) and is a non-solvent in which the resin is insoluble; (20) a method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 50:50, the solvent (B) is a poor solvent for the resin, and the solvent (C) is compatible with the solvent (B) and is a non-solvent in which the resin is insoluble; and (21) a method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 70:30, the solvent (B) is a poor solvent for the resin, and the solvent (C) is compatible with the solvent (B) and is a non-solvent in which the resin is insoluble.

The present invention makes it possible to provide a high strength polyethylene fiber having remarkably improved productivity. That is, since the productivity (the drawing property) is increased drastically without investment in large-scale facility, it is advantageous that high strength polyethylene fibers, which have been extremely expensive so far, can be provided at low cost.

### DETAILED DESCRIPTION OF THE INVENTION

The present invention will be described in detail.

A high molecular weight polyethylene, which is to be used as a raw material in the present invention, necessarily has an intrinsic viscosity [η] of 8 dL/g or more as measured by use of decalin as a measurement solvent at a measurement temperature of 135° C., and preferably has an intrinsic viscosity of 10 dL/g or more. This is because when the intrinsic viscosity is less than 8 dL/g, the desired high strength fiber having strength of more than 26 cN/dTex is not obtained. On the other hand, with regard to the upper limit, there are no particular problems as long as it is in the range that the desired strength can be obtained. However, if the intrinsic viscosity is more than 32 dL/g, the drawing property is deteriorated, so that it becomes difficult to obtain the effect of the present invention. The intrinsic viscosity is more preferably 30 dL/g or less, and even more preferably 25 dL/g or less.

The ultrahigh molecular weight polyethylene of the present invention is characterized in that its repeat units are substantially ethylene, and it may be a copolymer thereof with small amounts of other monomers such as α-olefin, acrylic acid and its derivatives, methacrylic acid and its derivatives, or vinyl silane and its derivatives, it may be a blend of these copolymers, or a copolymer with the polymer consisting of ethylene alone, and it even may be a blend with homopolymers of other α-olefins and the like.

The use of a copolymer with an α-olefin such as propylene or butene-1 to have a branch of short chain or long chain at a certain degree is particularly preferred in the production of these fibers, since yarn-making process is especially stabilized during spinning and drawing. However, since the excessive increase in the content of monomer other than ethylene can be disincentive for the drawing, from the viewpoint of obtaining a fiber having high strength and high elastic modulus, the content of the monomer other than ethylene is preferably 0.2 mol % or less in monomer unit, more preferably 0.1 mol % or less. As a matter of course, homopolymer consisting of ethylene alone may be used.

The important factor in a method for producing a high strength polyethylene fiber with high productivity of the present invention is the component dissolving (swelling) polyethylene, particularly the kind of solvent to be used in the preparation of a solution.

As the solvent for obtaining a high strength polyethylene fiber by a gel spinning method, decalin/tetralin and paraffin have hitherto been known, and these kinds of solvents were selected because polyethylene has high solubility to these solvents.

However, the inventors of the present invention found that the drawing property can be improved drastically by use of a solvent having a slightly lower solubility, instead of the above-mentioned good solvent (or in addition to such a good solvent) which has hitherto been believed to be optimum for producing a high strength polyethylene fiber, so that they accomplished the present invention. The reason why the drawing property is improved by the use of such a solvent having a slightly lower solubility is considered as follows.

The technical idea of the conventional gel spinning is to make a high molecular weight polyethylene resin into a easily-drawn state (molecules thereof are easily drawn) by swelling it with a solvent, and as a solvent, a good solvent, namely, a solvent which can swell the resin easily, has been used. However, from the viewpoint of productivity, it was found that when these solvents were used, the drawing property is insufficient, and that problems, such as frequent breakage of yarns and incapability of increasing the drawing rate in the drawing process which is one of the production processes of the polyethylene fiber, tend to occur. The inventors of the present invention focused their attention on the fact that the interaction between a solvent and polyethylene molecules is not involved only with the solubility, and extension of polyethylene molecules in the solution drastically varies depending on the kind of the solvent selected.

Specifically, it is considered that, when the molecular weight of polyethylene and the concentration of polyethylene molecules in a solution are fixed, polyethylene molecules extending to a less extent has a smaller occupied space in the solution for one molecule, as a result, the entanglement of polyethylene molecules is less. In other words, it is considered that the entanglement of molecules, which is believed to exert a large influence on drawing property in the production, can be reduced by selecting a solvent to decrease the extension of polyethylene molecules in the solution.

Regarding extension of polyethylene molecules dependent on the kind of solvent, a basic theory has been established as described, for example, in “Shin-Kobunshi Jikkengaku (New Macromolecule Experiments)”. A brief summary is as follows. When flexible macromolecules such as polyethylene and the like are dissolved in a good solvent having good solubility, if a pair of segments located at a long distance along a same molecule approach each other, a repulsive force becomes more predominant than an attractive force in the interaction between the segments, and thus the molecules tend to take a more extending state. On the other hand, when the flexible macromolecules are dissolved in a poor solvent having low solubiltiy, affinity between the molecules and the solvent is inferior and the attractive force becomes more predominant than the repulsive force in the interaction between the pair of segments, and thus the molecules tend to take a more shrunk state as compared with the case of using a good solvent. Therefore, when a poor solvent is used, extension of molecules in the solution decreases as compared with the case of using a good solvent. Consequently, it is considered that the entanglement of molecules decreases when using a poor solvent and thus it becomes possible to improve drawing property. It is well known that the extension of molecules in a solution is reflected by the measured value of intrinsic viscosity. As is apparent from enormous experimental data, the molecular weight dependency of the extension of molecules conforms to the following power-law in a region where molecular weight M is sufficiently high.

[η]∝M^{α}

In the formula, a denotes viscosity index. As a result of intensive study, it becomes possible to remarkably improve drawing property upon production by selecting the kind of solvent whose viscosity index satisfies specific conditions. That is, if a solvent has a viscosity index of 0.6 or less, the drawing property will be improved remarkably. On the other hand, although the lower limit of viscosity index is not particularly limited, if the viscosity index is less than 0.50, the solubility of polyethylene decreases and the spinnability and drawing property adversely tend to decrease. Accordingly, the viscosity index is more preferably from 0.50 to 0.59, and even more preferably from 0.50 to 0.57. The solvent having a viscosity index of greater than 0.6 or the solvent having a viscosity index of 0.6 or less can be selected from the polyethylene solvents, for example, described in “Polymer Handbook Fourth Edition”, Chapter 4 (John Wiley 1999)).

A solvent which improves the productivity remarkably in the present invention can be prepared by various methods. Examples thereof include the solvent consisting of one or at least two poor solvents, the solvent prepared by mixing one or at least two poor solvents and/or non-solvents to one or at least two good solvents, and the solvent prepared by mixing one or at least two non-solvents to one or at least two poor solvents.

The high strength polyethylene fiber of the present invention preferably contains a poor solvent in an amount of 10 ppm or more. In the present invention, a high strength polyethylene fiber can be produced by drawing the cooled dope filament after removing the solvent, or performing the removal of solvent and the drawing simultaneously, and performing multistep drawing depending on the situations. At this time, the residual amount of the poor solvent in the yarn is considered as an important parameter and is preferably 10 ppm or more. When the residual amount of the poor solvent in the yarn is less than 10 ppm, yarn breakage occurs very frequently in the drawing process. While the mechanism is not clear, it is considered that the residual solvent serves as a plasticizer. Although the upper limit is not particularly a problem to the drawing property, if it is more than 10,000 ppm, the elastic modulus and strength of the fiber tend to decrease due to the effect as a plasticizer. A more preferable range is from 50 ppm to 5000 ppm, and even more preferably from 100 ppm to 1,000 ppm.

The method of providing a poor solvent to a fiber is not particularly restricted, and it may be provided, for example, during spinning or drawing. However, it is preferable to add it during the preparation of a dope and maintain the poor solvent concentration not lower than 10 ppm during the drawing.

The poor solvent in the present invention is a solvent dissolving polyethylene and has a viscosity index of 0.6 or less.

The viscosity index of the poor solvent contained in the high strength polyethylene fiber of the present invention is preferably 0.6 or less, as described above. This is because such a poor solvent can lead to a moderate entanglement. As mentioned above, a more preferable range is from 0.51 to 0.59, and even more preferably from 0.52 to 0.57.

At this time, a deformation rate of the fiber during drawing is considered as an important parameter. If the deformation rate of the fiber is too large, the breakage of the fiber occurs before arriving at a sufficient drawing ratio, therefore it is not preferred. Also, if the deformation rate of the fiber is too small, molecular chain is relaxed during drawing and the fiber having excellent physical properties can not be obtained although the fiber becomes thin by drawing, therefore it is not preferred. The deformation rate is preferably 0.005 sec⁻¹ or more and 0.5 sec⁻¹ or less, and more preferably 0.01 sec⁻¹ or more and 0.1 sec⁻¹ or less. The deformation rate can be calculated from the drawing ratio of the fiber, the drawing rate and the length of heating section of an oven. That is, deformation rate (sec⁻¹)=(1-1/drawing ratio) drawing rate/length of heating section.

The ultrahigh molecular weight polyethylene fiber of the present invention is preferably the one produced by preparing a polyethylene dope having a polyethylene concentration of 0.5% by weight or more and less than 50% by weight from an ultrahigh molecular weight polyethylene resin having an intrinsic viscosity of 8 dL/g or more by use of a solvent having a viscosity index of 0.6 or less with respect to the resin, extruding the polyethylene dope through an orifice, cooling it, and then drawing a filament yarn. This is because if such method is used, the entanglement among molecules during spinning and drawing is moderate, and the productivity is improved remarkably.

Moreover, in one preferable embodiment, the ultrahigh molecular weight polyethylene fiber of the present invention is the one using a mixed solvent which contains a solvent (A) having a viscosity index of 0.6 or more in an amount of 20% by weight or more and less than 99% by weight, and a solvent (B) having a viscosity index of 0.6 or less in an amount of 1% by weight or more and less than 80% by weight. It is not preferred to use a mixed solvent containing the solvent (A) in an amount of 99% by weight or more and the solvent (B) in an amount of less than 1% by weight, because the effect on drawing property is small. It is not preferred to use a mixed solvent containing the solvent (A) in an amount of 20% by weight or less and the solvent (B) in an amount of 80% by weight or more, because the solubility of polyethylene drastically deteriorates.

It is more preferable that the solvent (A): the solvent (B)=30 :70 to 99:5 (weight ratio).

In another preferable embodiment, the ultrahigh molecular weight polyethylene fiber of the present invention contains a non-solvent in an amount of 10 ppm or more. This is because such fiber has excellent drawing property, and the productivity is remarkably improved. On the other hand, although the upper limit is not particularly limited, when 10,000 ppm or more is contained, the strength and elastic modulus tend to decrease. The content of the non-solvent is preferably within a range from 50 ppm to 5,000 ppm, and more preferably from 100 ppm to 1,000 ppm. The non-solvent of the present invention is a solvent in which an ultrahigh molecular weight polyethylene is insoluble, but is compatible with a good solvent or a poor solvent.

Moreover, the ultrahigh molecular weight polyethylene fiber of the present invention may be the one using a mixed solvent which contains a solvent (A) having a viscosity index of 0.6 or more in an amount of 50% by weight or more and less than 99% by weight, and a solvent (C) which is compatible with the solvent (A) and in which polyethylene is insoluble in an amount of 1% by weight or more and less than 50% by weight. It is not preferred to use a mixed solvent containing the solvent (A) in an amount of 99% by weight or more and the non-solvent (C) in an amount of less than 1% by weight, because effect is hardly obtained on drawing property. It is not preferred to use a mixed solvent containing the solvent (A) in an amount of less than 50% by weight and the non-solvent (C) in an amount of 50% by weight or more, because the solubility of polyethylene drastically deteriorates. It is more preferable that the solvent (A): the solvent (C)=70:30 to 90 :10 (weight ratio).

The high strength polyethylene fiber of the present invention preferably contains the solvents (B) and (C) in an amount of 10 ppm or more. This is because such a polyethylene fiber is extremely high in productivity. Although the upper limit is not particularly a problem to the drawing property, if it is more than 10,000 ppm, the elastic modulus and strength of the fiber tend to decrease due to the effect as a plasticizer. A more preferable range is from 50 ppm to 5000 ppm, and even more preferably from 100 ppm to 1,000 ppm.

Moreover, the ultrahigh molecular weight polyethylene fiber of the present invention may be the one using a mixed solvent which contains the solvent (B) in an amount of 50% by weight or more and less than 99% by weight, and a non-solvent (C) which is compatible with the solvent (B) and in which polyethylene is insoluble in an amount of 1% by weight or more and less than 50% by weight. It is not preferred to use a mixed solvent containing the solvent (B) in an amount of 99% by weight or more and the non-solvent (C) in an amount of less than 1% by weight, because effect is hardly obtained on drawing property. It is not preferred to use a mixed solvent containing the solvent (B) in an amount of less than 50% by weight and the non-solvent (C) in an amount of 50% by weight or more, because the solubility of polyethylene drastically deteriorates. It is more preferable that the solvent (B):the solvent (C) (weight ratio)=99:1 to 70:30.

In the method of the present invention, the polyethylene concentration in the solution may vary depending on properties of solvent and the molecular weight and the molecular weight distribution of polyethylene. When using polyethylene having a particularly high molecular weight, for example, having an intrinsic viscosity [η] of 14 dL/g or more as measured using decalin as a solvent at a measurement temperature of 135° C., brittle fracture easily occurs during spinning and it becomes very difficult to perform spinning, because a mixed dope having a concentration of 50% by weight or more becomes highly viscous. On the other hand, for example, a drawback using a mixed dope having a concentration of less than 0.5% by weight is that the yield decreases, and therefore the cost for the separation and recovery of solvent is increased.

The mixed dope to be used can be produced by various methods, for example, it can be produced by suspending a solid polyethylene in a solvent followed by stirring at high temperature, or it can be produced by suspending a solid polyethylene in a solvent followed by using a twin-screw extruder equipped with a mixing and conveying section.

In the method of the present invention, the mixed dope is passed through a spinneret having a plurality of aligned orifices to form a dope filament. The temperature of being converted into the dope filament must be selected from the temperature which is equal to or higher than the dissolving point. Of course, the dissolving point depends on the solvent and the concentration selected, and is preferably at least 140° C. or higher, and more preferably at least 150° C. or higher. Of course, this temperature is selected from the temperature which is equal to or lower than the decomposition temperature of polyethylene.

In the method of the present invention, the dope filament is cooled with a preliminarily rectified gas or a liquid. As the gas used in the present invention, air or an inert gas such as nitrogen or argon is used. As the liquid used in the present invention, water or the like is used.

### EXAMPLES

The invention will be described in detail below with reference to Examples, but the invention is not limited thereto.

Measurement methods and measurement conditions for the characteristic values in the present invention are as follows.

### (Intrinsic Viscosity)

Specific viscosities of various dilute solutions were measured with an Ubbelohde type capillary tube viscometer using decalin at the temperature of 135° C. Specific viscosities were divided by the concentration to give values which were then plotted versus the concentration. The obtained plots were approximated to a straight line by a least mean square method, and then the intrinsic viscosity was determined from the extrapolated point into the origin of the straight line. In the measurement, the solution for measurement was prepared by adding an antioxidant (Trademark “YOSHINOX BHT”, produced by Yoshitomi Pharmaceutical Industries Ltd.) in an amount of 1% by weight to polymer and dissolving the sample by stirring at 135° C. for 24 hours.

### (Viscosity Index)

Regarding a polyethylene solvent which is not described in documents such as “Polymer Handbook Fourth Edition” (John Wiley 1999), the viscosity index is determined by the following method.

A solution was prepared by dissolving polyethylene having a known weight average molecular weight of 50,000 or more and a molecular weight distribution with a single peak of 8 or less in a solvent. At this time, an antioxidant (Trademark “YOSHINOX BHT”, produced by Yoshitomi Pharmaceutical Industries Ltd.) is added to the solution in an amount of 1% by weight to polymer. Then, the intrinsic viscosity was determined in the same manner as described above. The same measurement was conducted for at least three or more kinds of polyethylene different in weight average molecular weight to determine the intrinsic viscosity, and then double logarithmical plotting of the intrinsic viscosity to the weight average molecular weight was conducted. The viscosity index was determined from the slope of a straight line which was obtained from the least squares approximation of the double logarithmical plot.

### (Strength and Elastic Modulus of Fiber)

The strength in the present invention was determined by measuring a strain-stress curve at an atmospheric temperature of 20° C. and a relative humidity of 65% by use of a “TENSILON” manufactured by Orientec Co. Ltd. under conditions of a sample length (distance between chucks) of 100 mm and an elongation speed of 100%/min, and calculating the strength (cN/dTex) from the stress and elongation at breakage point. The elastic modulus (cN/dTex) was determined by calculating from a tangent line which gives the greatest gradient in the vicinity of the origin of the curve. Each value was determined by averaging ten measured values.

In the fineness measurement, a single yarn having a length of about 2 m was taken out, the weight of the single yarn having the length of 1 m was measured, and the fineness (dTex) was obtained by converting it into the weight for 10,000 m.

### (Concentration of Residual Solvent in Yarn)

The concentration of the residual solvent in the yarn in the present invention is measured using a “Gas Chromatography” manufactured by Shimadzu Corporation. First, 10 mg of a sample yarn is set to the glass insert of the gas chromatography injection port. Subsequently, the injection port is heated to a temperature equal to or higher than the boiling point of the solvent and then the solvent generated by heating is introduced into a column by nitrogen purging. The column temperature is then set to 40° C. and the solvent is trapped for 5 minutes. Then, the measurement was started after the column temperature was raised to 80° C. The concentration of the residual solvent was determined from the resulting peak.

### Example 1

A slurry-like liquid was formed by using 1-decanol as a solvent and mixing an ultrahigh molecular weight polyethylene having an intrinsic viscosity of 21.0 dL/g at a weight ratio of 3:97. The substance was dissolved while being dispersed in a mixer type kneader equipped with two stirring blades set at a temperature of 160° C. to form a gel-like material. The gel-like material was filled into a circular cylinder set at a temperature of 185° C. without being cooled, and then was extruded at an extrusion rate of 0.8 g/min through a spinneret having one hole which was 0.8 mm in diameter and was set at a temperature of 170° C. The extruded dope filament was cooled by being introduced into a water bath through an air gap of 7 cm, and then taken up at a spinning rate of 20 m/min without removal of the solvent. Then, the dope filament was vacuum dried at 40° C. for 24 hours to remove the solvent. At this time, it was confirmed that the concentration of the residual solvent in the dope filament had not become less than 10 ppm. The resulting fiber was brought into contact with a metal heater set to 130° C. and drawn at a drawing ratio of 6 times, and then the drawn yarn was taken up. Then, the drawn yarn was further drawn at 149° C. and the drawing ratio was measured just before the breakage of the yarn, and the value thus obtained was taken as a maximum drawing ratio. The maximum drawing ratio was 17.5 times. Various physical properties of the resulting polyethylene fiber were shown in Table 1.

It was found that the resulting fiber had a large maximum drawing ratio and high strength and elastic modulus.

### Example 2

The fiber was produced in the same manner as Example 1 except that the slurry-like liquid was formed by mixing an ultrahigh molecular weight polyethylene having an intrinsic viscosity of 21.0 dL/g at a weight ratio of 3:97 in a mixed solvent of decahydronaphthalene and 1-octanol which were preliminarily mixed at a weight ratio of 50:50. When the fiber was drawn, the maximum drawing ratio was 18.0 times. Various physical properties of the resulting polyethylene fiber were shown in Table 1.

It was found that the resulting fiber had a large maximum drawing ratio and high strength and elastic modulus.

### Example 3

The fiber was produced in the same manner as Example 1 except that the slurry-like liquid was formed by mixing an ultrahigh molecular weight polyethylene having an intrinsic viscosity of 21.0 dL/g at a weight ratio of 3:97 in a mixed solvent of decahydronaphthalene and 1-dodecanol which were preliminarily mixed at a weight ratio of 50:50. When the fiber was drawn, the maximum drawing ratio was 18.5 times. Various physical properties of the resulting polyethylene fiber were shown in Table 1.

It was found that the resulting fiber had a large maximum drawing ratio and high strength and elastic modulus.

### Example 4

The fiber was produced in the same manner as Example 1 except that the slurry-like liquid was formed by mixing an ultrahigh molecular weight polyethylene having an intrinsic viscosity of 21.0 dL/g at a weight ratio of 3:97 in a mixed solvent of decahydronaphthalene and 1-hexanol which were preliminarily mixed at a weight ratio of 95:5, and the gel-like material was formed by dissolving the substance while being dispersed in a mixer type kneader equipped with two stirring blades set at a temperature of 170° C. When the fiber was drawn, the maximum drawing ratio was 18.0 times. Various physical properties of the resulting polyethylene fiber were shown in Table 1.

It was found that the resulting fiber had a large maximum drawing ratio and high strength and elastic modulus.

### Example 5

The fiber was produced in the same manner as Example 1 except that the slurry-like liquid was formed by mixing an ultrahigh molecular weight polyethylene having an intrinsic viscosity of 21.0 dL/g at a weight ratio of 3:97 in a mixed solvent of 1-decanol and 1-hexanol which were preliminarily mixed at a weight ratio of 98:2, and the gel-like material was formed by dissolving the substance while being dispersed in a mixer type kneader equipped with two stirring blades set at a temperature of 170° C. When the fiber was drawn, the maximum drawing ratio was 18.0 times. Various physical properties of the resulting polyethylene fiber were shown in Table 1.

It was found that the resulting fiber had a large maximum drawing ratio and high strength and elastic modulus.

### Comparative Example 1

The fiber was produced in the same manner as Example 1 except that the dope filament was obtained by using decahydronaphthalene as the solvent for polyethylene. When the fiber was drawn, the maximum drawing ratio was 14.0 times.

### Comparative Example 2

The fiber was produced in the same manner as Example 1 except that the dope filament was obtained by using tetralin as the solvent for polyethylene. When the fiber was drawn, the maximum drawing ratio was 8.0 times.

### Comparative Example 3

The fiber was produced in the same manner as Example 1 except that decalin and paraffin were used as the solvents for polyethylene as the usage disclosed in WO00/24952. When the fiber was drawn, the maximum drawing ratio was 15.0 times.

TABLE 1

| | Example | Example | Example | Example | Example | Example | Comparative | Comparative | Comparative |
|---|---|---|---|---|---|---|---|---|---|
| | 1 | 2 | 3 | 4 | 5 | 6 | Example 1 | Example 2 | Example 3 |
| Solvent having a viscosity | None | Decalin | Decalin | Decalin | None | Decalin | Decalin | Tetralin | Decalin, |
| index of 0.6 or more | | | | | | | | | Paraffin |
| Solvent having a viscosity | 1- | 1- | 1- | None | 1- | 1- | None | None | None |
| index of 0.6 or less | Decanol | Octanol | Dodecanol | | Decanol | Decanol | | | |
| Non-solvent | None | None | None | 1- | 1- | 1- | None | None | None |
| | | | | Hexanol | Hexanol | Hexanol | | | |
| Weight fraction of solvent | 0 | 50 | 50 | 95 | 0 | 90 | 100 | 100 | 100 |
| having a viscosity index of | | | | | | | | | |
| 0.6 or more [%] | | | | | | | | | |
| Weight fraction of solvent | 100 | 50 | 50 | 0 | 98 | 5 | 0 | 0 | 0 |
| having a viscosity index of | | | | | | | | | |
| 0.6 or less [%] | | | | | | | | | |
| Weight fraction of | 0 | — | — | 5 | 2 | 5 | 0 | 0 | 0 |
| non-solvent [%] | | | | | | | | | |
| Maximum drawing ratio [-] | 17.5 | 18.0 | 18.5 | 18.0 | 18.0 | 18.5 | 14.0 | 8.0 | 15.0 |
| Fineness [dTex] | 0.6 | 0.6 | 0.5 | 0.6 | 0.6 | 0.5 | 1.0 | 1.5 | 0.9 |
| Strength [cN/dTex] | 43 | 44 | 42 | 42 | 41 | 40 | 31 | 27 | 27 |
| Elastic modulus [cN/dTex] | 1208 | 1221 | 1176 | 1121 | 1185 | 1102 | 1019 | 604 | 720 |
| Residual amount of solvent | 0 | 180 | 190 | 180 | 0 | 661 | 88 | 70 | 4340 |
| having a viscosity index of | | | | | | | | | |
| 0.6 or more in yarn [ppm] | | | | | | | | | |
| Residual amount of solvent | 168 | 188 | 757 | 0 | 265 | 128 | 0 | 0 | 0 |
| having a viscosity index of | | | | | | | | | |
| 0.6 or less in yarn [ppm] | | | | | | | | | |
| Residual amount of | 0 | 0 | 0 | 488 | 124 | 68 | 0 | 0 | 0 |
| non-solvent in yarn [ppm] | | | | | | | | | |

The fiber obtained by the method for producing a high strength polyethylene fiber of the present invention can be widely used for industrial applications, for example, high performance textiles such as various sport wears, bulletproof/protective wears and protective gloves, and various safety goods; various rope products such as tag ropes, mooring ropes, yacht ropes, and building ropes; various braid products such as fishing lines and blind cables; net products such as fishing nets and ball-protecting nets; reinforcing materials or various nonwoven fabrics for chemical filters and battery separators; curtain materials such as tents; reinforcing fibers for sport goods such as helmets and ski boards, for speaker cones, and for composite applications such as prepregs and concrete reinforcing.

1. A high strength polyethylene fiber comprising an ultrahigh molecular weight polyethylene resin having an intrinsic viscosity of 8 dL/g or more, wherein the fiber contains a poor solvent in an amount of 10 ppm or more with respect to the resin.

2. The high strength polyethylene fiber according to claim 1, wherein the solvent has a viscosity index of 0.6 or less.

3. The high strength polyethylene fiber according to claim 1 produced by preparing a polyethylene dope having a polyethylene concentration of 0.5% by weight or more and less than 50% by weight from an ultrahigh molecular weight polyethylene resin having an intrinsic viscosity of 8 dL/g or more by use of a solvent having a viscosity index of 0.6 or less with respect to the resin, extruding the polyethylene dope through an orifice, and drawing a filament yarn after cooling.

4. The high strength polyethylene fiber according to claim 1 produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 20:80 to 99:1, the solvent (A) is a good solvent for the resin, and the solvent (B) is compatible with the solvent (A) and is a poor solvent for the resin.

5. The high strength polyethylene fiber according to claim 1 produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 30:70 to 95:5, the solvent (A) is a good solvent for the resin, and the solvent (B) is compatible with the solvent (A) and is a poor solvent for the resin

6. The high strength polyethylene fiber according to claim 4, wherein the solvent (A) has a viscosity index of greater than 0.6 with respect to the ultrahigh molecular weight polyethylene resin having an intrinsic viscosity of 8 dL/g or more, and the solvent (B) has a viscosity index of 0.6 or less.

7. A high strength polyethylene fiber comprising an ultrahigh molecular weight polyethylene resin having an intrinsic viscosity of 8 dL/g or more, wherein the resin contains a non-solvent in which the resin is insoluble in an amount of 10 ppm or more.

8. The high strength polyethylene fiber according to claim 7 produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 50:50 to 99:1, the solvent (A) is a good solvent for the resin, and the solvent (C) is compatible with the solvent (A) and is a non-solvent in which the resin is insoluble.

9. The high strength polyethylene fiber according to claim 7 produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 70:30 to 90:10, the solvent (A) is a good solvent for the resin, and the solvent (C) is compatible with the solvent (A) and is a non-solvent in which the resin is insoluble.

10. The high strength polyethylene fiber according to claim 8 using the mixed solvent, wherein the solvent (A) has a viscosity index of greater than 0.6 with respect to the ultrahigh molecular weight polyethylene resin having an intrinsic viscosity of 8 dL/g or more.

11. A high strength polyethylene fiber comprising an ultrahigh molecular weight polyethylene resin having an intrinsic viscosity of 8 dL/g or more, wherein the resin contains a solvent having a viscosity index of 0.6 or less with respect to the resin and a non-solvent in which the resin is insoluble in an amount of 10 ppm or more.

12. The high strength polyethylene fiber according to claim 11 produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 50:50, the solvent (B) is a poor solvent for the resin, and the solvent (C) is compatible with the solvent (B) and is a non-solvent in which the resin is insoluble.

13. The high strength polyethylene fiber according to claim 11 produced by preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 70:30, the solvent (B) is a poor solvent for the resin, and the solvent (C) is compatible with the solvent (B) and is a non-solvent in which the resin is insoluble.

14. The high strength polyethylene fiber according to claim 13, wherein the solvent (B) has a viscosity index of 0.6 or less with respect to the ultrahigh molecular weight polyethylene resin having an intrinsic viscosity of 8 dL/g or more.

15. A method for producing a high strength polyethylene fiber, comprising preparing a polyethylene dope having a polyethylene concentration of 0.5% by weight or more and less than 50% by weight from an ultrahigh molecular weight polyethylene resin having an intrinsic viscosity of 8 dL/g or more by use of a solvent having a viscosity index of 0.6 or less with respect to the resin, extruding the polyethylene dope through an orifice, and then drawing a filament yarn after cooling.

16. A method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 20:80 to 99:1, the solvent (A) is a good solvent for the resin, and the solvent (B) is compatible with the solvent (A) and is a poor solvent for the resin.

17. A method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (B), from 30:70 to 99:5, the solvent (A) is a good solvent for the resin, and the solvent (B) is compatible with the solvent (A) and is a poor solvent for the resin.

18. A method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 50:50 to 99:1, the solvent (A) is a good solvent for the resin, and the solvent (C) is compatible with the solvent (A) and is a non-solvent in which the resin is insoluble.

19. A method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (A):solvent (C), from 70:30 to 90:10, the solvent (A) is a good solvent for the resin, and the solvent (C) is compatible with the solvent (A) and is a non-solvent in which the resin is insoluble.

20. A method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 50:50, the solvent (B) is a poor solvent for the resin, the solvent (C) is compatible with the solvent (B) and is a non-solvent in which the resin is insoluble.

21. A method for producing a high strength polyethylene fiber, comprising preparing a mixed dope having a polyethylene concentration of 0.5% by weight or more and less than 50% by weight from an ultrahigh molecular weight polyethylene resin having an intrinsic viscosity of 8 dL/g or more by use of a mixed solvent, extruding the polyethylene dope through an orifice, and drawing a filament yarn after cooling, wherein the mixed solvent has a ratio (weight ratio) of, solvent (B):solvent (C), from 99:1 to 70:30, the solvent (B) is a poor solvent for the resin, the solvent (C) is compatible with the solvent (B) and is a non-solvent in which the resin is insoluble.

22. The high strength polyethylene fiber according to claim 4, wherein the solvent (A) has a viscosity index of greater than 0.6 with respect to the ultrahigh molecular weight polyethylene resin having an intrinsic viscosity of 8 dL/g or more, and the solvent (B) has a viscosity index of 0.6 or less.

23. The high strength polyethylene fiber according to claim 8 using the mixed solvent, wherein the solvent (A) has a viscosity index of greater than 0.6 with respect to the ultrahigh molecular weight polyethylene resin having an intrinsic viscosity of 8 dL/g or more.

24. The high strength polyethylene fiber according to claim 12, wherein the solvent (B) has a viscosity index of 0.6 or less with respect to the ultrahigh molecular weight polyethylene resin having an intrinsic viscosity of 8 dL/g or more.
